(19) United States
(12) Patent Application Publication
(10) Pub. No.: US 2025/0030699 A1
(43) Pub. Date: Jan. 23, 2025

(54) MULTI-TENANT RATE LIMITING SERVICE FOR DISTRIBUTED SYSTEMS

(71) Applicant: VMWARE, Inc., Palo Alto, CA (US)

(72) Inventors: LALITH SURESH PUTHALATH, Mountain View, CA (US); Pooja Khandelwal, Pune (IN); Mirza Mohsin Beg, Foster City, CA (US)

(21) Appl. No.: 18/376,007

(22) Filed: Oct. 3, 2023

(30) Foreign Application Priority Data
Jul. 19, 2023 (IN) 202341048499

(51) Int. Cl. H04L 9/40

(52) U.S. Cl. CPC H04L 63/108

(57) ABSTRACT

The disclosure provides a method for configuring rate limiting policies for microservices in a request execution chain of a distributed system. The method generally includes receiving global rate limit(s), where each global rate limit is associated with a tag and a microservice of a plurality of microservices, and each global rate limit indicates a rate of requests tagged with the tag associated with the global rate limit allowed to be processed by the microservice associated with the global rate limit; and configuring, for each global rate limit: each of the local rate limiter(s) associated with microservice instance(s) associated with the global rate limit with a local rate limit indicating a rate of requests tagged with the tag associated with the global rate limit allowed to be processed by the microservice instance, wherein the local rate limit of each of the local rate limiter(s) is based on the global rate limit.

### RELATED APPLICATIONS

Benefit is claimed under 35 U.S.C. 119 (a)-(d) to Foreign application No. 202341048499 filed in India entitled “A MULTI-TENANT RATE LIMITING SERVICE FOR DISTRIBUTED SYSTEMS”, on Jul. 19, 2023, by VMware, Inc., which is herein incorporated in its entirety by reference for all purposes.

Cloud native technologies, including microservices, have become a dominant force in software development and have proven to be vital to modern application delivery. In particular, the term microservices refers to an architectural approach to building applications. With a microservices architecture, an application is built as independent components that run each process of the application as a service. In other words, a microservices architecture organizes an application as a collection of linked services that may loosely connect via application programming interfaces (APIs). Each service may perform a single function. Because the services are independently run, each service can be updated, deployed, and/or scaled to meet demand for specific functions of an application. The microservices approach helps to enable organizations to adapt more quickly to changing demands, as well as, accelerate the delivery of new software features.

In today's digital landscape, Software-as-a-Service (SaaS) platforms have proven to be a popular choice for deploying microservices. A SaaS platform is a software distribution platform in which a software provider hosts cloud-based applications and/or cloud-based services, such as microservices, and makes them available to end users over the Internet. In this model, end users pay a monthly or annual fee to use such applications from within, for example, a web browser, desktop client, and/or mobile application. The cloud-based applications/services and all of the infrastructure required to deliver these applications/services—servers, storage, networking, middleware, application software, and data storage—are hosted and managed by the software provider. As such, end users of these cloud-based applications/services are not tasked with the setup and/or maintenance of the software.

Multi-tenant software architecture, also referred to as software multitenancy, is the architecture on which SaaS is generally delivered. In particular, in multi-tenant software architecture, a single instance of a cloud-based, software application or service (e.g., microservice) and its supporting infrastructure (e.g., its underlying hardware) serves multiple tenants (or user accounts). A tenant may be an individual user and/or a group of users, such as an organization, that shares common access to and privileges within the application or microservice instance. Each tenant's data is isolated from, and invisible to, the other tenants sharing the application/microservice instance, ensuring data security and privacy for all tenants.

Providing performance guarantees in such multi-tenant, distributed application (e.g., microservices) systems is a technically challenging problem. In particular, the system may receive requests from multiple tenants/users accessing an application distributed as a plurality of microservices in the system (e.g., such as several independent services used to perform operations that make up a business process). Accordingly, fulfilling these requests may require the execution of more than one microservice in the system, each with its own resource utilization limits. Each of these microservices used to fulfill the request may be owned by a different entity, for example, a different business unit within an organization, and each entity may protect its corresponding microservice from overload by configuring various rate limiting policies (e.g., local rate limiting policies) to account for these resource limits.

Rate limiting is a technique used to control the rate at which requests are made to a microservice. It is a strategy for managing and regulating traffic flow to ensure that the microservice remains available and responsive. Rate limiting may be achieved by placing restrictions on the number of requests that can be accepted and processed by the microservice over a specified period of time. In some cases, these restrictions are more granularly defined for specific tenants, users, organizations, and/or the like which generate these requests for the microservice. For example, different rate limits may be applied for different tenants to restrict or meter resource usage of the various tenants to prevent cases where one tenant starves other tenants from resources allocated to the microservice thereby degrading performance for the other tenants. Accordingly, rate limiting may be applied per microservice, and further per user, tenant, organization, etc. of each microservice. This idea of local rate limiting (also referred to as “distributed rate limiting”) allows each entity to exercise backpressure and manage overload within the boundaries they control, or more specifically, for a microservice they manage (e.g., overload happens when conditions cause a microservice to exhaust its resources so that it fails to handle incoming requests). However, protecting each participating microservice against overload via local rate limiting without understanding the global usage is not operationally practical. For example, in some cases, local rate limiting may leave upstream services with no option but to fail ungracefully, use compensating transactions (described in the example below), and/or perpetual retries, all with no guarantee of success.

As an illustrative example, a microservice-based order management system may be designed to include multiple microservices that each perform a service for receiving, tracking, and fulfilling a purchase order for an item sold by an online retailer. The microservices may include an order service (e.g., designed to receive the purchase order and store/save the order data in a database), an inventory checking service, a billing service, a customer notification service, a logistics service, a delivery/shipping service, and an order tracking service. Each of these services may be owned by a single business unit of the online retailer, and each business unit may specify local rate limits that are to be applied to the microservice owned by that business unit. The order service may be the first service to receive the purchase order (e.g., a request) from a customer making the purchase. Local rate limits applied to the order service may permit the order service to carry out one or more operations for the received purchase order before transmitting the request to a next service configured to carry out the execution of the request (e.g., the inventory service, the billing service, etc.). For this example, it may be assumed that the inventory service and the billing service are able to successfully verify that the item purchased by the customer is, indeed, in stock as well as process payment for the item. However, due to local rate limits specified for the user and applied to the customer notification service, the customer notification service may be unable to inform the customer that its purchase has been confirmed and processed (e.g., customer notification service rejected processing the request due to restrictions on the number of requests that could be accepted and processed by the service). In this case, a compensating transaction may be performed to reverse the effects of the original transaction and refund the user's money. Performing the compensation transaction may involve each of the billing service, the inventory service, and the order service “undoing” operations previously completed to fulfill the purchase order. Systems where compensation transactions are consistently needed, due to local rate limits applied to different microservices in the system, may adversely impact performance of the system (e.g., due to resource waste) and further, overall customer experience.

Although local rate limiting without understanding the global usage is problematic in distributed systems, for the reasons described above, it may also be impractical for a human operator to calibrate rate limits across microservices in the system. In particular, rate limits are set based on the operational behavior and resource capacity of each microservice, which may constantly change over time as each microservice is upgraded. Requiring recalibration of rate limits each time such updates occur, for each service in the topology (e.g., in some cases, a large number of services), may not be efficient, or even pragmatic. Further, this becomes more impractical when recalibration is required for each request type or tag (e.g., such as users, tenants, organizations, etc. that are used for more granular rate limiting) change over time.

Although difficult to implement across a service topology of a distributed system (e.g., microservices deployed in a multi-tenant SaaS platform), rate limiting techniques are essential to the resiliency of the system. In particular, correctly configuring rate limits is essential to avoid system overload, avoid service level agreement (SLA) violations, to limit the impact (or potential) of cascading failures (e.g., failure in a system of interconnected parts in which the failure of one or few parts leads to the failure of other parts), and/or avoid isolation issues with shared resources-all of which compromise system reliability and performance.

### SUMMARY

One or more embodiments provide a method for configuring rate limiting policies for a plurality of microservices in a request execution chain of a distributed system. The method generally includes receiving, by a global rate limiter, one or more global rate limits. Each global rate limit of the one or more global rate limits is associated with a corresponding tag and a corresponding microservice of the plurality of microservices. Further, each global rate limit of the one or more global rate limits indicates a rate of requests tagged with the corresponding tag associated with the global rate limit allowed to be processed by the corresponding microservice associated with the global rate limit. The method generally includes configuring, by the global rate limiter, for each global rate limit of the one or more global rate limits: each of one or more local rate limiters associated with one or more instances of the corresponding microservice associated with the global rate limit with a local rate limit. The local rate limit configured for each of the one or more local rate limiters indicates a rate of requests tagged with the corresponding tag associated with the global rate limit allowed to be processed by the instance of the corresponding microservice associated with the global rate limit. The local rate limit of each of the one or more local rate limiters is based on the global rate limit.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A illustrates a computing system in which embodiments described herein may be implemented.

FIG. 1B illustrates an example container-based cluster for running containerized applications in the computing system of FIG. 1A, according to an example embodiment of the present disclosure.

FIG. 2 provides an example distributed system designed to centrally configure rate limiting policies for microservices deployed in the system, according to an example embodiment of the present disclosure.

FIG. 3 provides an example rate limiting configuration that may be provided to a centralized rate limiting service, according to an example embodiment of the present disclosure.

FIG. 4 provides example permits for a tag that are locally enforced by a microservice where rate limiting policies are configured, according to an example embodiment of the present disclosure.

FIG. 5 provides an example workflow for processing a request received by a microservice in a service topology where rate limiting techniques are implemented, according to an example embodiment of the present disclosure.

FIG. 6 provides an example workflow for performing rate limiting by a local rate limiter, according to an example embodiment of the present disclosure.

FIG. 7 provides an example service topology where rate limiting policies are centrally configured, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for centrally configuring rate limiting policies for a distributed system are described herein. The distributed system may include a plurality of independent and loosely coupled microservices used to carry out a function for the system. For example, the microservices may be designed to communicate with each other (e.g., using application programming interfaces (APIs)) to perform specific functions, such as data processing.

According to embodiments described herein, the microservices may also be in communication with a global rate limiter of a centralized rate limiting service. The centralized rate limiting service is responsible for configuring and dynamically adjusting rate limits for each participating microservice in the distributed system, via the global rate limiter. In particular, the centralized rate limiting service allows one or more tags to be identified, as well as rate limits for each of the tag(s) for a given microservice. As used herein, a tag is metadata assigned to a request received by the microservice that is used to classify a request. For example, a tag may provide context about a user that generated the request, a tenant that generated the request, an organization that generated the request, a geographical location where the request was generated, and/or other criteria for which an administrator requests rate limiting on. Each request received by a microservice may be assigned one or more tags. The centralized rate limiting service uses rate limiting and tag information defined for each microservice in the system to identify a number of permits to allocate to each local rate limiter in the system. In certain aspects, each permit is associated with a tag and a microservice. Accordingly, each permit for a microservice associated with a tag may allow the local rate limiter to allow one request for the microservice also associated with the tag to be sent to the microservice to be processed. If the local rate limiter does not have a permit for a request, the local rate limiter may indicate that the request is to be denied or dropped by the microservice, instead of indicating that the request can be processed, or indicate the request is to be put in a queue until the local rate limiter has a permit for the request (e.g., by requesting permits from a global rate limiter). In certain aspects, where a request for a microservice is associated with multiple tags, to allow the request to be processed by the microservice, multiple local rate limiters, each associated with a different tag, may need a separate permit for the microservice, to each allow the request to be processed by the microservice. If even one of the local rate limiters associated with a tag also associated with the request does not have a corresponding permit, the request may not be processed by the microservice.

Specifically, in addition to having a global rate limiter, a plurality of local rate limiters are deployed for each microservice. The number of local rate limiters deployed for a microservice depends on (1) a number of instances of the microservice in the system as well as (2) a number of tags declared for the microservice (e.g., for rate limiting purposes). For example, where two instances of a first microservice exist (e.g., the second instance is a replica of the first microservice) and three tags are defined for the first microservice, then six local rate limiters are deployed for the first microservice. The central rate limiting service, via the global rate limiter, may be configured to allocate permits to each of these local rate limiters to effectively limit a number of requests received by each instance of the microservice assigned one or more tags. A number of permits allocated to each local rate limiter may specify a number of requests permitted for a tag associated with that local rate limiter. Accordingly, a tagged request received by an instance (e.g., a replica) of a first microservice may be processed if a local rate limiter for that tag associated with the microservice instance has available permits, otherwise the request is rejected, thereby effectively enforcing rate limiting of requests at the microservice instance.

In certain embodiments, the global rate limiter limits a number of permits allocated to one or more local rate limiters to account for bottlenecks in the system. For example, if a downstream microservice in a request execution chain (e.g., a shared database) is bottlenecked, the global rate limiter may determine to dynamically throttle requests upstream in the execution chain (e.g. at upstream microservice(s), such as an ingress gateway). Throttling the requests upstream may involve allocating a limited number of permits (and/or permits with a shorter expiration period) to one or more local rate limiters (e.g., associated with upstream microservice(s)). In doing so, the global rate limiter aims to permit only requests upstream that would not later need to be throttled at the bottlenecked, downstream microservice (e.g., reject request(s) as far upstream as possible that are likely to be throttled at a downstream bottlenecked, microservice). This provides a failing-fast system configured to reduce requests processed at upstream microservice(s) in a request execution chain rather than trying to continue working around bottlenecks that are expected to occur, and/or are occurring, at downstream microservice(s) in the chain. As such, resource waste along the request execution chain may be avoided and/or the risk of cascading failures may be reduced.

In certain embodiments, the global rate limiter limits a number of permits allocated to one or more local rate limiters to account for bottlenecks in the system caused by a tag associated with those rate limiters. For example, requests from one or more tenants (e.g., requests tagged with metadata specifying the one or more tenants) may be contributing to a bottleneck at a downstream service. To help mitigate the bottleneck at the downstream service, the global rate limiter may limit a number of permits allocated to local rate limiters associated with one or more upstream microservices for the tenant(s) contributing to the bottleneck. As such, rate limiting configured for the system may allow for throttling requests from those tenants, without having to penalize other tenants also using microservices in the system. Allowing for this level of throttling across loosely coupled systems may enable a consumption-based licensing model for operational telemetry products. In particular, a consumption-based licensing model may be used to permit only a limited number of requests/resources per user (e.g., based on the user's subscription).

The global rate limiter, described herein for use in distributed systems, may be used in any distributed system where requests are capable of being tagged (or classified). Further, the global rate limiter may be configured to allocate permits to local rate limiter(s) of different microservices based on an arbitrary hierarchy of casually propagated tags, as opposed to only a single tag. This helps to enable a complex mix of real-world resource management policies. For example, the global rate limiter is able to monitor and enforce permits by tag for the microservices it operates even in cases where administrators of each these microservices declare their own policies (e.g., resource limits) and tags.

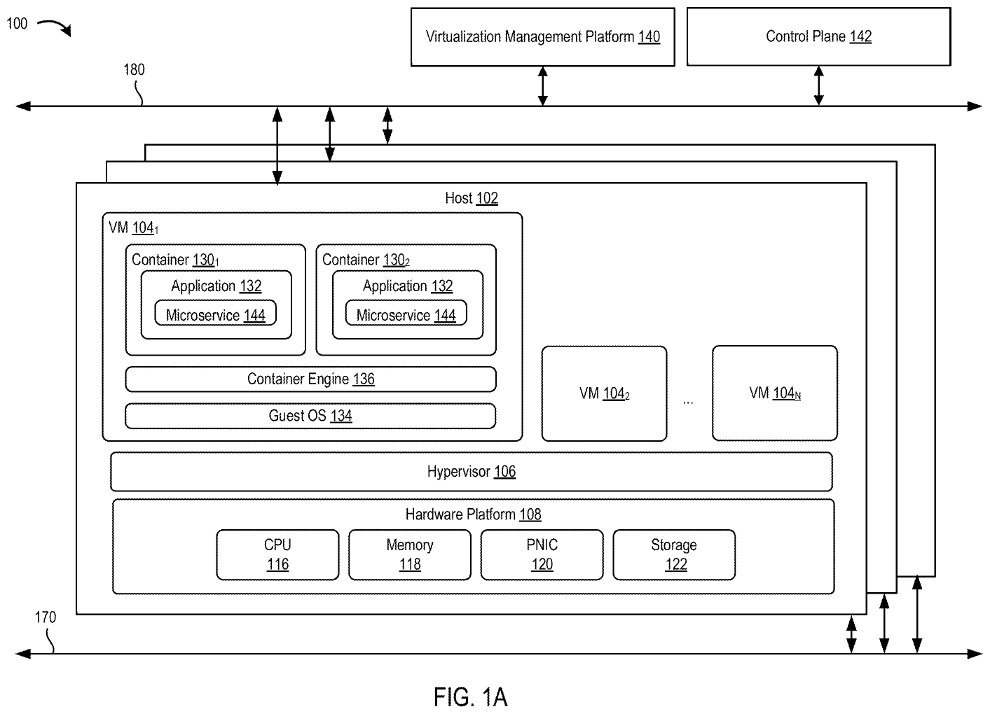

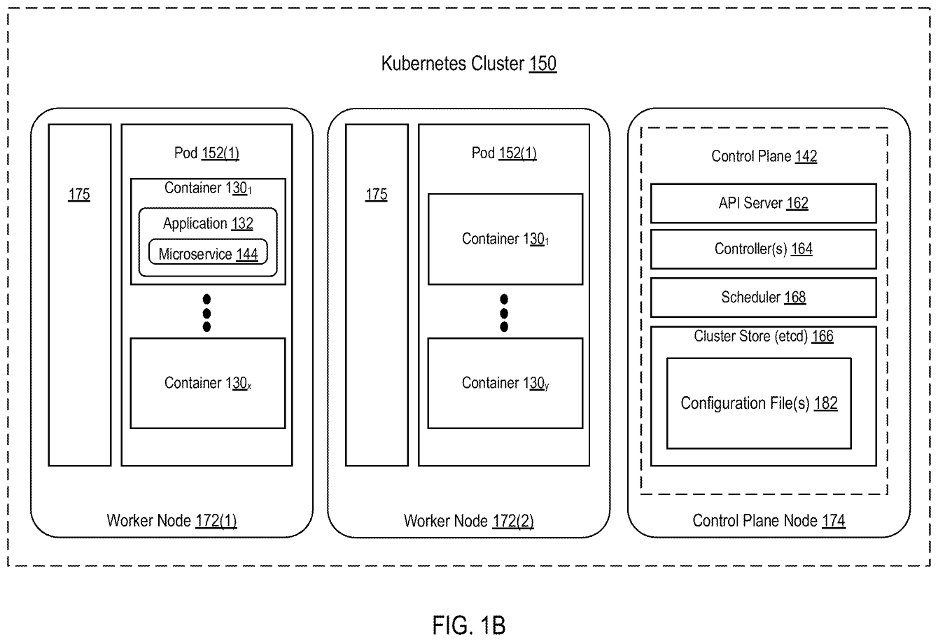

FIG. 1A is a block diagram that illustrates a computing system 100 in which embodiments described herein may be implemented. Computing system 100 includes one or more hosts 102, a management network 180, a data network 170, and a virtualization management platform 140.

Host(s) 102 may be geographically co-located servers on the same rack or on different racks in any arbitrary location in the data center. Host(s) 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 104₁ to 104_{N} (collectively referred to as VMs 104 and individually referred to as VM 104) that run concurrently on the same host 102.

Host(s) 102 may be constructed on a server grade hardware platform 108, such as an x86 architecture platform. Hardware platform 108 of each host 102 includes components of a computing device such as one or more processors (central processing units (CPUs)) 116, memory (random access memory (RAM)) 118, one or more network interfaces (e.g., physical network interfaces (PNICs) 120), storage 122, and other components (not shown). CPU 116 is configured to execute instructions that may be stored in memory 118, and optionally in storage 122. The network interface(s) enable hosts 102 to communicate with other devices via a physical network, such as management network 180 and data network 170.

In certain embodiments, hypervisor 106 runs in conjunction with an operating system (OS) (not shown) in host 102. In some embodiments, hypervisor 106 can be installed as system level software directly on hardware platform 108 of host 102 (often referred to as “bare metal” installation) and be conceptually interposed between the physical hardware and the guest OSs executing in the VMs 104. It is noted that the term “operating system,” as used herein, may refer to a hypervisor. One example of hypervisor 106 that may be configured and used in embodiments described herein is a VMware ESXi™ hypervisor provided as part of the VMware vSphere® solution made commercially available by VMware, Inc. of Palo Alto, CA.

Each of VMs 104 implements a virtual hardware platform that supports the installation of a guest OS 134 which is capable of executing one or more applications 132. Guest OS 134 may be a standard, commodity operating system. Examples of a guest OS include Microsoft Windows, Linux, and/or the like. Applications 132 may be any software program, such as a word processing program.

In certain embodiments, computing system 100 includes a container orchestrator. The container orchestrator implements a container orchestration control plane (also referred to herein as the “control plane 142”) to deploy and manage applications 132 and/or services thereof on hosts 102 using containers 130. In particular, each VM 104 includes a container engine 136 installed therein and running as a guest application under control of guest OS 134. Container engine 136 is a process that enables the deployment and management of virtual instances, referred to herein as “containers,” in conjunction with OS-level virtualization on guest OS 134 within VM 104 and the container orchestrator.

Containers 130 provide isolation for user-space processes executing within them. Containers 130 encapsulate an application 132 and/or a microservice 144 as a single executable package of software that bundles application code together with all of the related configuration files, libraries, and dependencies required for it to run. As described above, a microservice 144 is an independent component of an application 132 that runs a process of the application 132 as a service.

Control plane 142 runs on a cluster of hosts 102 and may deploy containerized applications 132 and/or microservices 144 as containers 130 on the cluster of hosts 102. Control plane 142 manages the computation, storage, and memory resources to run containers 130 in the host cluster.

In certain embodiments, control plane 142 deploys and manages applications as pods of containers 130 running on hosts 102, either within VMs 104 or directly on an OS of hosts 102. A pod is a group of one or more containers 130 and a specification for how to run the containers 130. A pod may be the smallest deployable unit of computing that can be created and managed by control plane 142.

In certain embodiments, control plane 142 is a Kubernetes control plane. Kubernetes® (K8S®) is an example open-source container orchestration platform that automates the deployment and operation of containerized applications 132 and/or microservices 144. Kubernetes may be used to create a cluster of interconnected nodes, including (1) one or more worker nodes that run the containerized applications 132 and/or microservices 144 (e.g., in a worker plane) and (2) one or more control plane nodes (e.g., in a control plane 142) having control plane components running thereon that control the cluster. Control plane components make global decisions about the cluster (e.g., scheduling), and can detect and respond to cluster events. As used herein, a node may be a physical machine, such as host 102, or a VM configured to run on a physical machine running a hypervisor, such as VM 104 running on hypervisor 106 of host 102.

An example Kubernetes cluster 150 for running containerized applications 132 and/or microservices 144 is illustrated in FIG. 1B. While the example container-based cluster shown in FIG. 1B is a Kubernetes cluster 150, in other examples, the container-based cluster may be another type of container-based cluster based on container technology, such as Docker Swarm clusters. As illustrated in FIG. 1B, Kubernetes cluster 150 is formed from (1) one or more worker nodes 172 that run one or more pods 152 having containers 130 and (2) one or more control plane nodes 174 having control plane components running thereon that control the cluster (e.g., where a node is a physical machine, such as a host 102, or a VM 104 configured to run on a host 102).

Each worker node 172 includes a kubelet 175. Kubelet 175 is an agent that helps to ensure that one or more pods 152 run on each worker node 172 according to a defined state for the pods 152, such as defined in a configuration file. Each pod 152 may include one or more containers 130. The worker nodes 172 can be used to execute various applications 132 and software processes using containers 130. Further, each worker node 172 may include a kube proxy (not illustrated in FIG. 1B). A kube proxy is a network proxy used to maintain network rules. These network rules allow for network communication with pods 152 from network sessions inside and/or outside of Kubernetes cluster 150.

Control plane 142 (e.g., running on one or more control plane nodes 174) includes components such as an application programming interface (API) server 162, controller(s) 164, a cluster store (etcd) 166, and scheduler(s) 168. Control plane 142's components make global decisions about Kubernetes cluster 150 (e.g., scheduling), as well as detect and respond to cluster events.

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. The kube-apiserver is designed to scale horizontally—that is, this component scales by deploying more instances. Several instances of kube-apiserver may be run, and traffic may be balanced between those instances.

Controller(s) 164 is responsible for running and managing controller processes in Kubernetes cluster 150. As described above, control plane 142 may have (e.g., four) control loops called controller processes, which watch the state of Kubernetes cluster 150 and try to modify the current state of Kubernetes cluster 150 to match an intended state of Kubernetes cluster 150.

Scheduler(s) 168 is configured to allocate new pods 152 to worker nodes 172.

Cluster store (etcd) 166 is a data store, such as a consistent and highly-available key value store, used as a backing store for Kubernetes cluster 150 data. In certain embodiments, cluster store (etcd) 166 stores configuration file(s) 182, such as JavaScript Object Notation (JSON) or YAML files, made up of one or more manifests that declare intended system infrastructure and workloads to be deployed in Kubernetes cluster 150. Kubernetes objects, or persistent entities, can be created, updated and deleted based on configuration file(s) 182 to represent the state of Kubernetes cluster 150. A Kubernetes object is a “record of intent”—once an object is created, the Kubernetes system will constantly work to ensure that object is realized in the deployment. One type of Kubernetes object is a custom resource definition (CRD) object that extends API server 162 or allows a user to introduce their own API into Kubernetes cluster 150. In particular, Kubernetes provides a standard extension mechanism, referred to as custom resource definitions, that enables extension of the set of resources and objects that can be managed in a Kubernetes cluster.

Given the above, control plane 142 manages and controls every component of Kubernetes cluster 150. Control plane 142 handles most, if not all, operations within Kubernetes cluster 150, and its components define and control Kubernetes cluster 150's configuration and state data. Control plane 142 configures and runs the deployment, management, and maintenance of the containerized applications 132, and in some cases, their corresponding microservices 144. As such, ensuring high availability of the control plane may be critical to container deployment and management. High availability is a characteristic of a component or system that is capable of operating continuously without failing.

Accordingly, in certain embodiments, control plane 142 operates as a high availability control plane. Additional details of high availability control planes are disclosed in U.S. Application Ser. No. 63/347,815, filed on Jun. 1, 2022, and titled “AUTONOMOUS CLUSTERS IN A VIRTUALIZATION COMPUTING ENVIRONMENT,” which is hereby incorporated by reference herein in its entirety.

Microservices 144, deployed as containers 130, may be implemented in various topologies; however, common characteristics among these topologies include (1) a distributed architecture and (2) the notion of separately deployed units. In particular, microservices architecture is an example distributed architecture, meaning that all the microservices 144 within the architecture are fully decoupled from one other (e.g., each microservice 144 is deployed as an independent unit/service) and accessed through some sort of remote access protocol (e.g., java message service (JMS), advanced message queuing protocol (AMQP), representational state transfer (REST), etc.). The distributed nature of this architecture is how microservices architecture achieves some of its superior scalability and deployment characteristics.

Each of these loosely coupled microservices 144 may participate to fulfill a single request. In other words, request execution in microservices architecture may span more than one microservice 144. For example, a plurality of microservices 144 in a system may “talk” to each other using APIs (e.g., lightweight APIs) connected to interfaces to perform specific business functions, such as monetary transactions, invoice creation, and data processing. Each microservice 144 may be designed to perform a portion of the tasks (e.g., less than all tasks) needed to successfully carry out these business functions. As such, although a requestor (e.g., who submits the request) sees a single request-response flow when interacting with the system, behind the scenes, many microservices 144 may be working to fulfill the request.

In certain embodiments, rate limiting techniques are used in such distributed systems to help ensure the fair usage of microservices 144 by various users, tenants, organizations, geographical locations, etc. Rate limiting may also be used to protect the system from denial of service (DOS) attacks (e.g., where a malicious actor initiates a large number of service requests in a short time period) and/or protect each individual microservice 144 in the system from overload. Rate limiting regulates the rate at which requests are made to a microservice 144 to help ensure that the microservice 144 remains available and responsive.

Because microservices 144 in a service topology are often owned by different entities (e.g., business units) of a larger organization, management of these microservices 144, including the management of resources via rate limiting techniques, may be individually decided and implemented by each entity for microservices 144 owned by that entity (e.g., referred to as “local rate limiting” or “distributed rate limiting”). As described above, managing resources to protect each participating microservice 144 against overload via local rate limiting techniques, without understanding the global resource usage among microservices 144 in the system, may not be operationally practical and/or may cause issues with microservices 144 upstream in a process flow. Further, it may not be efficient and/or feasible to manually configure every participating microservice 144 in the topology given applications (and their corresponding microservices 144), topologies, resource limits, and request characteristics may change dynamically and/or evolve over time.

To overcome the aforementioned technical problems associated with rate limiting in distributed systems and improve upon the state of the art, techniques described herein propose implementing a centralized rate limiting service in such distributed systems. The centralized rate limiting service is responsible for configuring and dynamically adjusting rate limits for each participating microservice in the distributed system, via a global rate limiter. In particular, the centralized rate limiting service uses global rate limiting and tag information defined for each microservice in the system to identify a number of permits to allocate to each microservice in the system, and more specifically a number of permits to allocate to each local rate limiter introduced in the system for each microservice. Each local rate limiter deployed for a microservice in the system enables rate limiting of tagged requests for each instance of that microservice. A number of permits allocated to each local rate limiter may specify a number of requests permitted for a tag associated with that local rate limiter. Accordingly, a tagged request received by an instance (e.g., a first instance or a replica of the first instance) of a microservice may be processed if a local rate limiter for that tag associated with the microservice instance has available permits, otherwise the request is rejected, thereby effectively enforcing rate limiting of requests at the microservice instance.

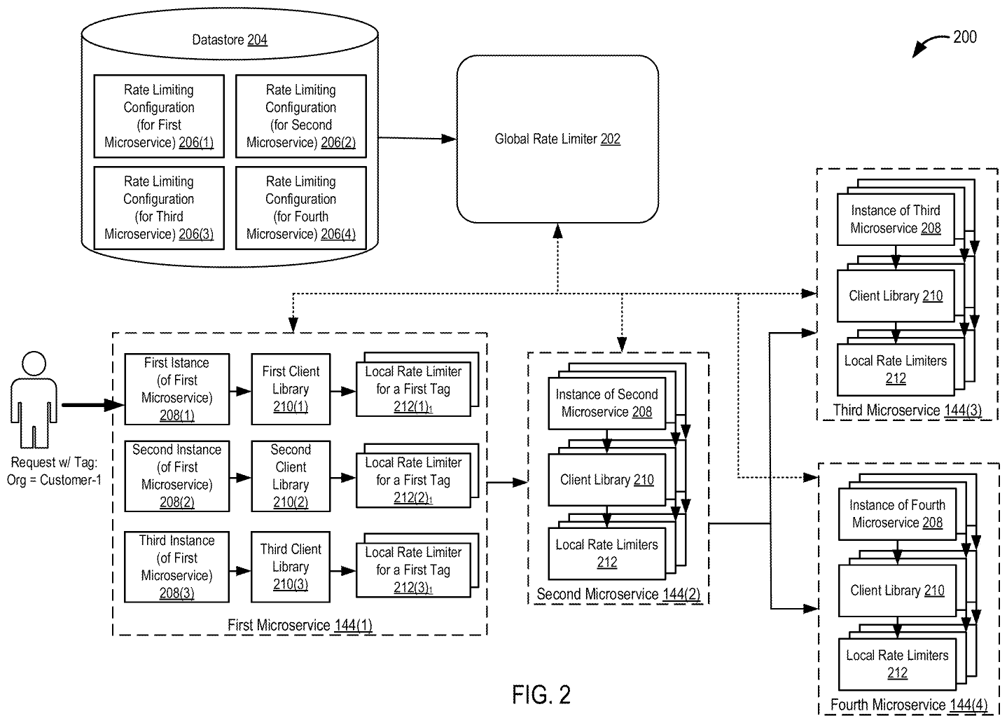

FIG. 2 provides an example distributed system 200 designed to centrally configure rate limiting policies for microservices deployed in system 200, according to an example embodiment of the present disclosure. As illustrated, distributed system 200 includes a global rate limiter 202, a database 204, and four microservices 144 distributed across distributed system 200 (e.g., first microservice 144(1), second microservice 144(2), third microservice 144(3), and fourth microservice 144(4)).

Together, microservices 144 are used to carry out one or more functions for system 200. For example, as illustrated by the solid black line in FIG. 2, a first function may be performed by first microservice 144(1), second microservice 144(2), and third microservice 144(3). Further, a second function may be performed by first microservice 144(1), second microservice 144(2), and fourth microservice 144(4). Each of these functions may be initiated based on requests received by first microservice 144(1). For example, where first microservice 144(1), second microservice 144(2), and third microservice 144(3) together are configured for invoice creation, the invoice creation may be triggered by first microservice 144(1) receiving a request to create an invoice. To fulfill the request, operations may be performed by first microservice 144(1), second microservice 144(2), and third microservice 144(3) (e.g., microservices 144 in a request execution chain).

To configure and dynamically adjust rate limits for each microservice 144 in distributed system 200, system 200 includes global rate limiter 202. Global rate limiter 202 may be running on a physical machine (e.g., server) with a hypervisor (e.g., host 102 with hypervisor 106 in FIG. 1) or without a hypervisor, running on a VM (e.g., VM 104 in Figure), and/or running on other virtual computing instances (VCIs).

Global rate limiter 202 is configured to translate declarative rate limiting policies defined for each microservice 144 in system 200 (e.g., defined as global rate limits in rate limiting configurations 206 in database 204) into individual rate limit permit quotas enforced locally by each microservice 144 (and more specifically, as described below, each instance 208 of each microservice 144).

For example, global rate limiting information for each respective microservice 144 in distributed system 200 may be obtained by global rate limiter 202. In certain embodiments, the rate limiting configurations 206 are generated by an administrator (e.g., a human operator). In certain embodiments, the rate limiting configurations 206 are machine-generated. Machine-generated rate limiting configurations 206 may be based on deployment configurations, capacities, topologies, and/or, in some cases, information included in a Kubernetes custom resource definition (CRD) (e.g., a configuration file 182 in cluster store (etcd) 166 in FIG. 1B).

Each rate limiting configuration 206, for each microservice 144, may include information about one or more tags that are to be used for rate limiting at the microservice 144, as well as declare global rate limits for each of the tag(s) (e.g., “global” in this context refers to a rate limit for all instances 208 of the respective microservice 144). Tags are key-value pairs that are assigned to requests received by microservices 144 in distributed system 200. For example, tags assigned to requests may include user-ids, tenant-ids, org-ids, quality of service classes (e.g., high/low priority), and/or top-level API UUIDs that triggered the request for execution. Each request may include one or more tags. For instance, a single request may be assigned the following tags: [user=alice, qos-class=premium-user, org-id=customer-1], where “user,” “qos-class,” and “org-id” are keys of the tags and “alice,” “premium-user,” and “customer-1” are values for each of those keys, respectively.

Tags assigned to different requests may be based on tags defined for microservices 144 (e.g., in rate limiting configurations 206) in a request execution chain used to fulfill the request. For example, a request that is to be executed by first microservice 144(1), second microservice 144(2), and third microservice 144(3) may be assigned one or more tags defined for each of these microservices, but may not be assigned a tag defined for fourth microservice 144(4) as this microservice 144 is not in the request execution chain.

Tagging requests allows for rate limiting of different tagged requests at each of the microservices 144. For example, to enable first microservice 144(1) to accept and process more requests received from a first user (e.g., user-id=first user) than a second user (e.g., user-id=second user), user-id tags may be defined for the first microservice 144(1) and used to tag requests received by first microservice 144(1). Based on the tag associated with the request received, first microservice 144(1) may apply different rate limits. Tags assigned to a request may be propagated throughout a request execution chain in distributed system 200, to allow for tracing of tags by global rate limiter 202. Global rate limiter may use this tracing information to track arrival rates of requests at each of the microservices 144 in a request execution chain to be able. As described in detail below, global rate limiter 202 may use the tracing information and arrival rate information to dynamically adjust rate limits for different tags, at different microservices 144 and/or different microservice instances 208 in distributed system 200.

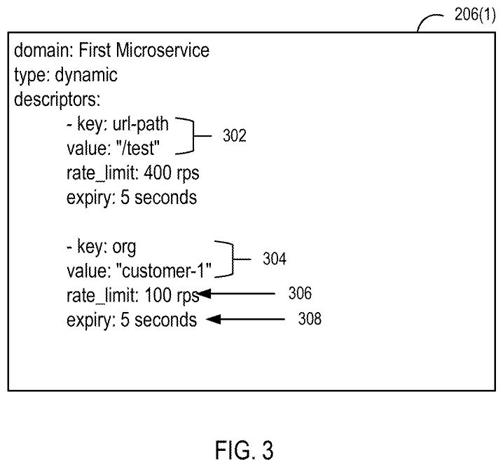

FIG. 3 provides an example rate limiting configuration 206(1) defined for first microservice 144(1) in distributed system 200. As illustrated, two tags 302, 304 (e.g., key-value pairs) are defined for first microservice 144(1). The first tag 302 is url-path: “/test” where “url-path” is the key and ‘“/test”’ is the value. The second tag 304 is org: customer-1 where “org” is the key and “customer-1” is the value. Further, rate limiting configuration 206(1) defines for each tag 302, 304 a rate limit (e.g., referred to herein as a “global rate limit”), and a timescale over which the rate limit holds. For example, a rate limit 306 identified for second tag 304 is 100 requests per second (rps) and a timescale over which the rate limit holds (e.g., denoted as “expiry” at 308) is five seconds. This indicates that only 100 requests from “customer-1” per second, received by first microservice 144(1) (e.g., tagged with org: customer-1), may be accepted and processed by instances 208 of first microservice 144(1) together (e.g., first instance 208(1), second instance 208(2), and third instance 208(3)). Any request over 100 received by any instance 208 of first microservice 244(1) from customer-1, per second, may be rejected by that instance 208 of first microservice 144(1) when this rate limiting configuration 206(1) is applied to first microservice 144(1). Further, setting the expiry field equal to five seconds in rate limiting configuration 206(1) may allow for re-synchronization of a global rate limit for tag 304 after five seconds, for example, in cases where there is an under-utilization of the requests per second allocated to tag 304 in rate limiting configuration 206(1).

Although global rate limits defined for tags 302 and 304 in example rate limiting configuration 206(1) illustrated in FIG. 3 are defined as rates per second, in other configurations, the global rate limits may be defined in other units, for example, as rates per minute.

Although not illustrated in example rate limiting configuration 206(1), in certain embodiments, rate limiting configurations 206 defined for microservices 144 may include regular expression(s) and/or range(s). For instance, a rate limiting configuration 206(1) may indicate for a tag [user: \hat{ }xyz-*] that the allocated rate limit is 50 rps. Lookups of such tags for defined rate limits may follow a precedence order of exact matches, then regular expression (regex)-based matches, and then range-based matches.

Global rate limiter 202 obtains the information included in rate configuration files 206 (e.g., in database 204) and uses this information to automatically calibrate local rate limiters 212 associated with microservices 144 in distributed system 200, and more specifically, microservices 144 in a request execution chain to help ensure that the “capacity” of each microservice 144 (e.g., the global rate limit, expressed in rps, for each tag) is not exceeded when fulfilling requests received at these microservices 144. Calibrating local rate limiters 212 includes global rate limiter 202 determining a number of permits (and an expiration time for these permits) to allocate to each local rate limiter 212 and allocating this determined amount of permits to each local rate limiter 212. For example, each permit may allow one request to be processed, as discussed further herein.

In particular, local rate limiters 212 are deployed for each tag defined for each microservice 144, and for each instance 208 of each microservice 144. For example, three tags may be defined for first microservice 144(1), where each tag corresponds to a unique customer (e.g., tags include org: Customer-1, org: Customer-2, and org: Customer-3). Further, three instances of first microservice 144(1) may be running in distributed system 200. Accordingly, nine local rate limiters 212 may be deployed for microservice 144(1). Three of the nine total local rate limiters 212 may be associated with the first instance 208(1) (of first microservice 144(1)), another three of the nine total local rate limiters 212 may be associated with the second instance 208(2) (of first microservice 144(1)), and the final three of the nine total local rate limiters 212 may be associated with the third instance 208(3) (of first microservice 144(1)). The three local rate limiters 212 associated with first instance 208(1) (of first microservice 144(1)) may each correspond to one of the tags org: Customer-1, org: Customer-2, and org: Customer-3 (e.g., first local rate limiter 212 is associated with tag “org: Customer-1,” second local rate limiters 212 is associated with tag “org: Customer-2,” and third local rate limiter 212 is associated with tag “org: Customer-3”).

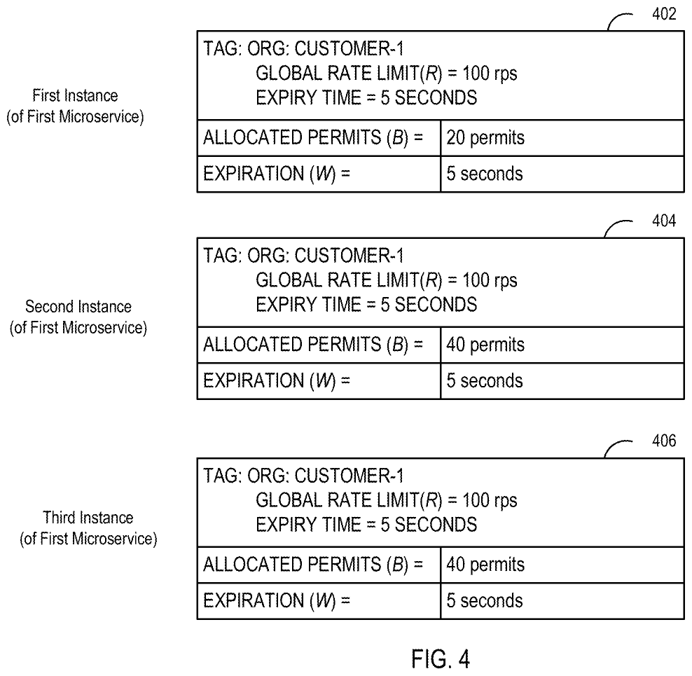

Permits allocated, by global rate limiter 202 for a time window (W), to each local rate limiter 212 associated with a same tag, for a microservice 144, may not exceed the global rate limit defined for the tag and for the microservice in rate limiting configuration 206. FIG. 4 provides example permits 402, 404, 406 that may be allocated to each local rate limiter 212 associated with each instance 208 (of first microservice 144(1)) for a tag “org: Customer-1.” As illustrated in FIG. 4, the aggregate number of permits allocated to each local rate limiter 212 for a time window (W) for tag “org: Customer-1” does not exceed the global rate limit (R) defined for the tag in rate limiting configuration 206(1). In particular, the aggregate number of tags/W<R.

In particular, the global rate limit (R) defined for tag “org: Customer-1” for first microservice 144(1) may be equal to 100 rps in rate limiting configuration 206(1). As such, only 100 requests may be accepted and processed by first instance 208(1), second instance 208(2), and third instance 208(3) of first microservice 144(1) per second (e.g., on average over a number of seconds, per each second, etc.). Thus, when calibrating a local rate limiter 212 for this tag at each of these instances 208, global rate limiter 202 may only allocate up to 100 permits per second for the indicated expiry time (e.g., 100 rps×5 seconds=500 permits total).

In this example, global rate limiter 202 allocates 20 permits (allocated permits (B)=20) to a first local rate limiter 212(1) associated with tag “org: Customer-1” and first instance 208(1) (of first microservice 144(1)). Global rate limiter 212 allocates 40 permits (B=40) to a second local rate limiter 212(2) associated with tag “org: Customer-1” and second instance 208(2) (of first microservice 144(1)). Further, global rate limiter 212 allocates 40 permits (B=40) to a third local rate limiter 212(3) associated with tag “org: Customer-1” and third instance 208(3) (of first microservice 144(1)). Global rate limiter 212 indicates that each of these permits are to be used within a time window (W) of 5 seconds. As such, the maximum number of permits that may be used by microservice 144(1), within the 5 second window, is equal to 100 permits (e.g., 20 permits+40 permits+40 permits=100 permits), which is an average of 100/5=20 permits per second, which is within the global rate limit of 100 permits per second. In this way, global rate limiter 202 ensures that the maximum number of permits that may be used by all instances 208 of microservice 144(1) per second (e.g., 20 permits per second) is less than, or equal to, the global rate limit (R) (e.g., 100 rps). Calibrating each local rate limiter 212 for tag “org: Customer-1” and microservice 144(1) may performed for all local rate limiters 212 at the same time or may be performed separately for each local rate limiter 212 (e.g., as described in detail below).

Global rate limiter 202 may similarly determine a number of permits to allocate to each local rate limiter 212 for each tag declared for use by each microservice 144 in distributed system 200, and further for each instance 208 of each microservice 144.

In certain embodiments, the number of permits per time window allocated, by global rate limiter 202, to local rate limiters 212 associated with a tag and a microservice 144 is less than the global rate limit (R) declared for the tag and the microservice 144. For example, the number of per-tag permits allocated to an upstream microservice 144 per time window in a request execution chain may be less than the global rate limit (R) defined for the tag and the microservice 144 to help with bottlenecks at one or more downstream microservices 144, resulting from processing requests associated with the tag. As an illustrative example, global rate limiter 202 may be monitoring permit use at first microservice 144(1), second microservice 144(2), and third microservice 144(3) when executing a request. Based on this monitoring, global rate limiter 202 may determine that third microservice 144(3) is overwhelmed, specifically due to a large number of requests from Customer-1 (e.g., large number of requests tagged with tag “org: Customer-1”). Because tags are attached to requests that flow throw the execution request chain, global rate limiter 202 may be able to determine at what upstream microservices these requests tagged with “org: Customer-1” are coming from, including first microservice 144(1). Global rate limiter 202 may automatically adjust the permits allocated per time window to local rate limiters 212 for instances 208 of microservice 144(1) to be less than the currently/previously allocated amount of permits per time window to limit the number of “org: Customer-1” requests that are accepted and processed upstream. Limiting the number of permits allocated upstream helps to reduce resource waste along the request execution chain and/or the risk of cascading failures.

As another illustrative example, first microservice 144(1) may be a gateway service and second microservice 144(2) may be a database service. Global rate limiter 202 may observe that every request with a tag “api-call: auth-get” at first microservice 144(1) (e.g., the gateway service) leads to five requests, on average, at second microservice 144(2) (e.g., the database service). To enforce a global rate limit of 100 rps at second microservice 144(2) for this specific class of requests (e.g., requests tagged with “api-call: auth-get”), global rate limiter 202 may determine that a total of 20 permits per time window of 1 second are to be allocated to instances 208 of first microservice 144(1), such that at most 20 requests are processed at first microservice 144(1) per second, leading to 100 requests per second at second microservice 144(2).

Permits allocated to a local rate limiter 212 may be used to determine whether or not a request received by an instance 208 of a microservice 144, associated with the local rate limiter 212, may be accepted and processed by the instance 208. As such, dynamically allocating permits to local rate limiters 212 in distributed system 200 may effectively enforce rate limiting requests at each instance 208, and thereby enforce rate limits for the associated microservice 144.

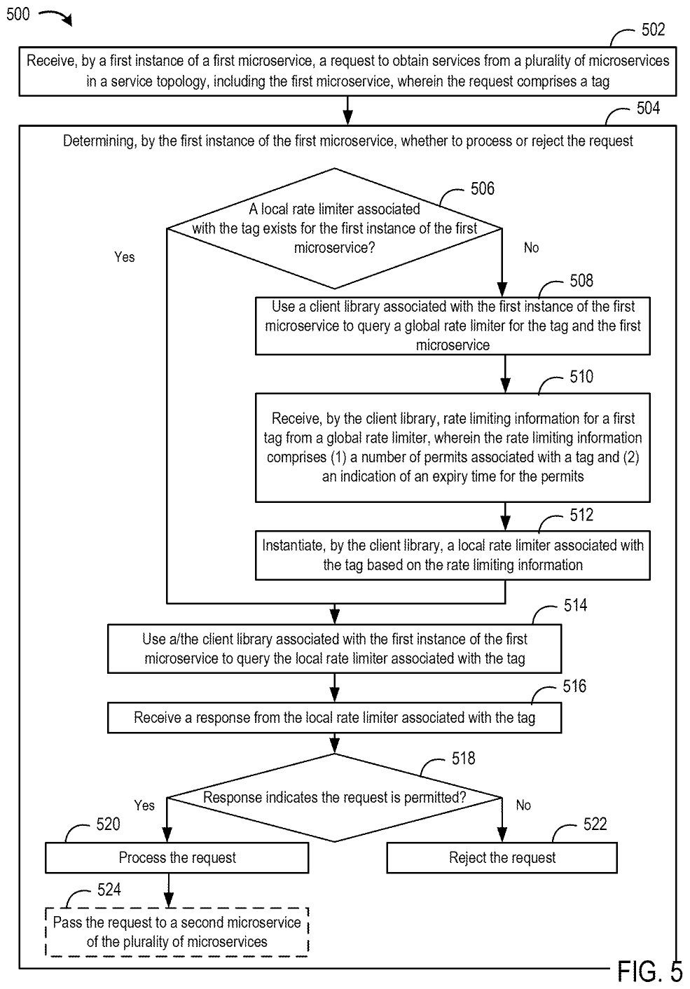

FIG. 5 provides an example workflow 500 for processing a request received by microservice 144 in a service topology where rate limiting techniques are implemented, according to an example embodiment of the present disclosure. For example, workflow 500 may be performed to determine whether a request received by first instance 208(1) of first microservice 144(1), in FIG. 2, is to be processed or rejected.

As illustrated in FIG. 2, the request may be generated by Customer-1; thus, the request may include a tag “org: Customer-1” where “org” is the key and “Customer-1” is the value. In certain embodiments, the request is tagged at an ingress gateway of distributed system 200 (not shown in FIG. 2). In certain embodiments, the request is tagged at an ingress service (e.g., another microservice 144 in the request execution chain including microservice 144(1)) (not shown in FIG. 2).

Further, in certain embodiments, a load balancer (not shown in FIG. 2) is deployed between the user (e.g., belonging to org: Customer-1, in this case) that sends the request and a microservice 144 for which the request is intended for, as well as between a microservice 144 in a request execution chain prior to a microservice 144 next in the request execution chain. The load balancer may be responsible for distributing requests received for the intended microservice 144 among instances 208 of that microservice 144, such that the request is received by one or more instance 208 of that microservice 144 for processing. In certain other embodiments, each microservice 144 includes its own load balancing mechanism used to distribute requests received at the microservice 144 among instance(s) of that microservice 144.

Workflow 500 begins, at operation 502, by first instance 208(1) of first microservice 144(1) receiving the request comprising the tag “org: Customer-1.” The request may call for services from a plurality of microservices, including first microservice 144(1).

Workflow 500 proceeds, at operation 504, by first instance 208(1) determining whether to process the request received for tag “org: Customer-1.” Determining whether to process the request, at operation 504, includes performing operations 506-522 (and optionally, operation 524).

At operation 506, first instance 208(1) determines whether a local rate limiter 212(1) associated with the tag exists for first instance 208(1) of microservice 144(1). A local rate limiter 212(1) associated with the tag may exist where a local rate limiter 212(1) was previously instantiated for the tag and for first instance 208(1), as well as allocated a batch of permits for the tag from global rate limiter 202.

If, at operation 506, first instance 208(1) determines that a local rate limiter 212(1) associated with first instance 208(1) does not exist, then at operation 508, a first client library 210(1) associated with first instance 208(1) of first microservice 144(1) is used to query global rate limiter 202 for tag “org: Customer-1” and first microservice 144(1). In certain embodiments, first client library 210(1) uses a hypertext transfer protocol (HTTP) GET request to query global rate limiter 202. Querying global rate limiter 202 may be used to determine a number of permits that are allowed for processing requests with tag “org: Customer-1” for first instance 208(1), such as within a time window.

First client library 210(1) is a collection of code specific to one programming language that makes it easier to use an API, and specifically in this case, an API used to look up and query a global rate limiter 202 or a local rate limiter 212(1) for one or more tags associated with a request. First client library 210(1) is a client library deployed specifically for use by first instance 208(1) of first microservice 144(1). In particular, a client library 210 may be deployed per microservice instance 208. Each client library 210, deployed per microservice instance 208, only interacts with a set of rate limiters (e.g., local rate limiters 212) that correspond to the microservice 144 and the tags of requests received by the microservice 144. Example client libraries 210 include Google Guava libraries (e.g., a set of core Java libraries) made available by Google of Mountain View, CA.

Using client libraries 210 allows microservice 144 developers to build client libraries 210 in any programming language, while still enabling interaction with global rate limiter 202 and/or local rate limiters 212 in a distributes system. As such, the rate limiting techniques described herein for distributed systems may be a re-used/deployed for any client-server architecture.

At operation 510, first client library 210(1) receives rate limiting information for tag “org: Customer-1” from global rate limiter 202 (e.g., in response to the query). The rate limiting information may include (1) a number of permits allocated for tag “org: Customer-1” (at first instance 208(1) of first microservice 244(1)) and (2) an indication of an expiry time for the permits.

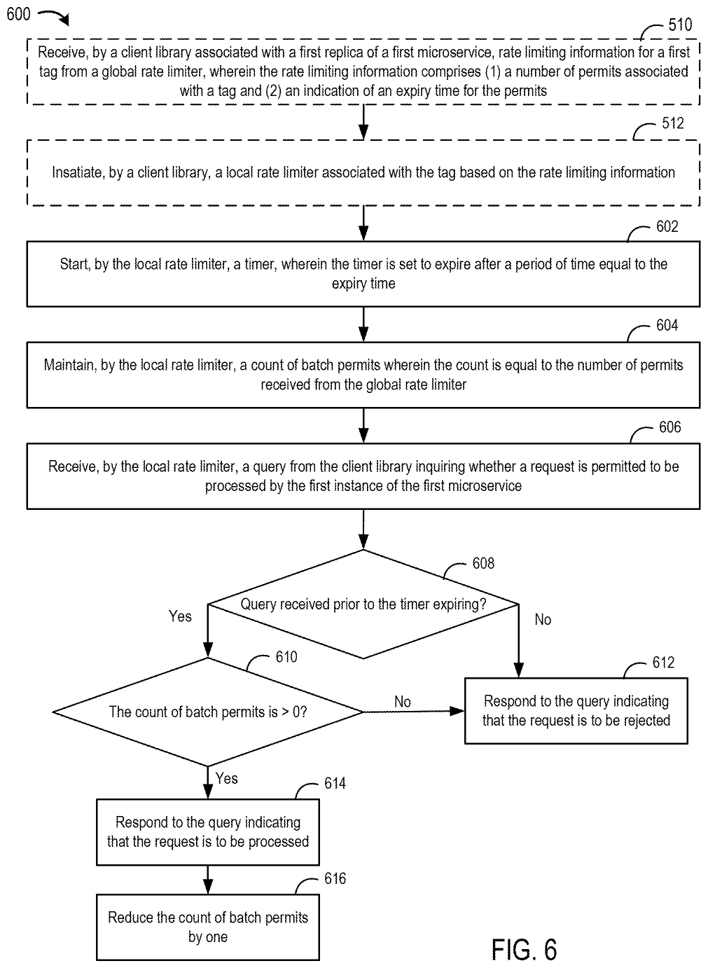

At operation 512, first client library 210(1) instantiates a local rate limiter 212(1)₁ associated with tag “org: Customer-1” based on the rate limiting information received from global rate limiter 202. In other words, local rate limiter 212(1)₁ is deployed to limit requests for tag “org: Customer-1,” received at first instance 208(1), to the number of permits allocated to local rate limiter 212(1)₁. For example, in a case where local rate limiter 212(1)₁ is allocated 20 permits from global rate limiter 202 (e.g., set to expire in 10 seconds), then when a 21^{st} request having the tag “org: Customer-1” is received by first instance 208(1) (e.g., within the 10 seconds, and before more permits are allocated), local rate limiter 212(1)₁ may determine that this reject is to be rejected. Enforcing permits, by local rate limiters 212, for rate limiting are described in more detail with respect to FIG. 6.

Instantiating local rate limiter 212(1)₁ associated with tag “org: Customer-1” (e.g., for first instance 208(1)) reduces the need for client library 210(1) to query global rate limiter 202 each time a request received by first instance 208(1) has the tag “org: Customer-1.” While querying global rate limiter 202 for every request would accurately enforce the appropriate global rate limit for tagged requests received at an instance 208 of a microservice 144, this design would scale poorly, given it requires querying the centralized rate limiting service (e.g., global rate limiter 202) on the critical path of every single request, thereby becoming a scalability bottleneck. Thus, embodiments herein propose the use of a distributed rate limiter design (as described herein), where permits are distributed among local rate limiters associated with different instances 208 and tags for each microservice 144, which allows for tuning to balance salability with resource utilization.

At operation 514, client library 210(1) is used to query local rate limiter 212(1)₁ instantiated at operation 512. Querying local rate limiter 212(1)₁ lets first instance 208(1) asks local rate limiter 212(1)₁ whether instance 208(1) should process or reject the request received by instance 208(1) (e.g., at operation 502).

Returning to operation 506, if a local rate limiter 212(1) associated with tag “org: Customer-1” does exist, then workflow 500 proceeds to operation 514 where client library 210(1) is used to query the existing local rate limiter 212(1), which, in this case, is local rate limiter 212(1)₁ associated with tag “org: Customer-1” and first instance 208(1). A local rate limiter 212(1) may exist for the tag where a request for this tag was previously received at instance 208(1) and operations 508-512 were performed to instantiate the local rate limiter 212(1) for the tag and for first instance 208(1).

At operation 516, a response from local rate limiter 212(1)₁ is received by first instance 208(1). The response from local rate limiter 212(1)₁ may be received in response to the query submitted to local rate limiter 212(1)₁ at operation 514.

Workflow 500 then proceeds, at operation 518, with first instance 208(1) determining whether the response indicates that the request (e.g., received at operation 502) is permitted. As described below with respect to FIG. 6, the request may be permitted if the number of permits available at local rate limiter 212(1)₁ is greater than zero and a timer set by local rate limiter 212(1)₁ for these permits has not expired.

If, at operation 518, first instance 208(1) determines that the response is permitted, then at operation 520, first instance 208(1) processes the request. Further, at operation 524, first instance 208(1) may pass the request to second microservice 144(2) for processing (e.g., the next microservice 144 in the request execution chain for the request).

Alternatively, if at operation 518, first instance 208(1) determines that the response is not permitted, then at operation 522, first instance 208(1) rejects the request.

FIG. 6 provides an example workflow 600 for performing rate limiting by a local rate limiter, according to an example embodiment of the present disclosure. For example, workflow 600 may be performed by local rate limiter 212(1)₁ deployed for tag “org: Customer-1” and first instance 208(1) in FIG. 5 (e.g., at operations 510 and 512). Workflow 600 may be performed by local rate limiter 212(1)₁ to determine whether the request received by first instance 208(1) (e.g., at operation 502 in FIG. 5) should be processed or rejected by first instance 208(1).

Workflow 600 begins, at operation 602, with local rate limiter 212(1)₁ starting a timer. The timer may be set based on the indication of an expiry time for the permits allocated by global rate limiter 202 (e.g., the indication provided to client library 210(1) at operation 510). More specifically, the timer may be set to expire after a period of time equal to the expiry time.

Workflow 600 proceeds, at operation 604, with local rate limiter 212(1)₁ maintaining a count of batch permits. The count of batch permits is equal to the number of permits allocated to local rate limiter 212(1)₁ by global rate limiter 202 (e.g., the number of permits received from global rate limiter 202 at operation 510).

Workflow 600 proceeds, at operation 606, with local rate limiter 212(1)₁ receiving a query from client library 210(1), associated with first instance 208(1), inquiring whether the request received by instance 208(1) is permitted to be processed by first instance 208(1). In response to receiving this query, local rate limiter 212(1)₁ determines whether the request can be processed. To determine whether the query can be processed by first instance 208(1), local rate limiter 212(1)₁ determines, at operation 608, whether the query was received prior to the timer expiring.

If, at operation 608, local rate limiter 212(1)₁ determines that the query was not received prior to the timer expiring (e.g., timer started at time 0 and set to run for 10 seconds, and the query was received after 12 seconds from starting the timer), then at operation 612, local rate limiter 212(1)₁ responds to the query indicating that the request is to be rejected.

Alternatively, if, at operation 608, local rate limiter 212(1)₁ determines that the query was received prior to the timer expiring (e.g., timer started at time 0 and set to run for 10 seconds, and the query was received after 4 seconds from starting the timer), then at operation 610, local rate limiter 212(1)₁ determines whether the count of batch permits maintained by local rate limiter 212(1)₁ is greater than zero. A count of batch permits greater than zero indicates to local rate limiter 212(1)₁ that the request can be processed because the processing limit for this type of tagged request received at first instance 208(1) has not yet been reached.

If, at operation 610, local rate limiter 212(1)₁ determines that the count of batch permits maintained by local rate limiter 212(1)₁ is greater than zero, then at operation 614, local rate limiter 212(1)₁ responds to the query indicating that the request is to be processed. Further, at operation 616, local rate limiter 212(1)₁ reduces the count of batch permits maintained by local rate limiter 212(1)₁ by one.

Alternatively, if, at operation 610, local rate limiter 212(1)₁ determines that the count of batch permits maintained by local rate limiter 212(1)₁ is not greater than zero (e.g., Permits=0), then at operation 612, local rate limiter 212(1)₁ responds to the query indicating that the request is to be rejected. The count of batch permits maintained by local rate limiter 212(1)₁ may be equal to zero where a number of requests received and processed by first instance 208(1) within a time period, for requests with tags “org: Customer-1,” is equal to the number of permits allocated to local rate limiter 212(1)₁ for the time period set by the timer.

In certain embodiments, permits allocated to local rate limiter 212(1)₁ are replenished. For example, client library 210(1) may again query global rate limiter 202 for permits for local rate limiter 212(1)₁ when client library 210(1) receives the rejection response at operation 612 (e.g., due to the timer maintained by local rate limiter 212(1)₁ being expired and/or no batch permits remaining).

### Example Implementation Details

In certain embodiments, to implement centralized rate limiting techniques described above in a distributed multi-tenant system (e.g., a client-server architecture), the centralized rate limiting service is deployed on a sever configured to use HTTP secure (HTTPS) and credential service provider (CSP) authentication. The server may be implemented in Java® using Java Springboot. The server may use an Aurora Postgre structure query language (SQL) instance, provided by Amazon Web Services (AWS) of Seattle Washington, for configuration and runtime statistics persistence. The server may offer two APIs: an administrative API to persist the configuration and a read API to retrieve permits. The administrative API may accept a human-readable YAML payload (e.g., similar to rate limiting configuration 206(1) illustrated in FIG. 3). This configuration may be persisted in a database and may also be kept in an object model in memory for quicker access. An administrator may use descriptor definitions with the same key-value tags as the clients use to retrieve permits.

For the client side of the client-server architecture, Google Guava rate limiters (e.g., example local rate limiters 212 described above) may be implemented to enforce permits. The initialization of each Google Guava rate limiter instance may be lazily performed when a first request for a permit is requested. For example, for the first request the rate limit acquired may be blocked until a Google Guava rate limiter is initialized with a count of permits and an expiration for those permits from the centralized rate limiting service at the server (e.g., via an HTTP GET REST call). The GET call may succeed with HTTP 200 and response body, only if the GET request contains descriptor key-value tags configured in the server for the tenant.

Further, in certain embodiments, a Caffeine Cache Bean (e.g., Caffeine is an open-source, high-performance Java caching library) with a custom expiration policy is used to get and expire the Google Guava rate limiters. In certain embodiments, a default expiry window for the permits allocated to the Google Guava rate limiters is set to be equal to ten seconds (e.g., set and defined at the centralize rate limiting service in the server).

### Example Implementation

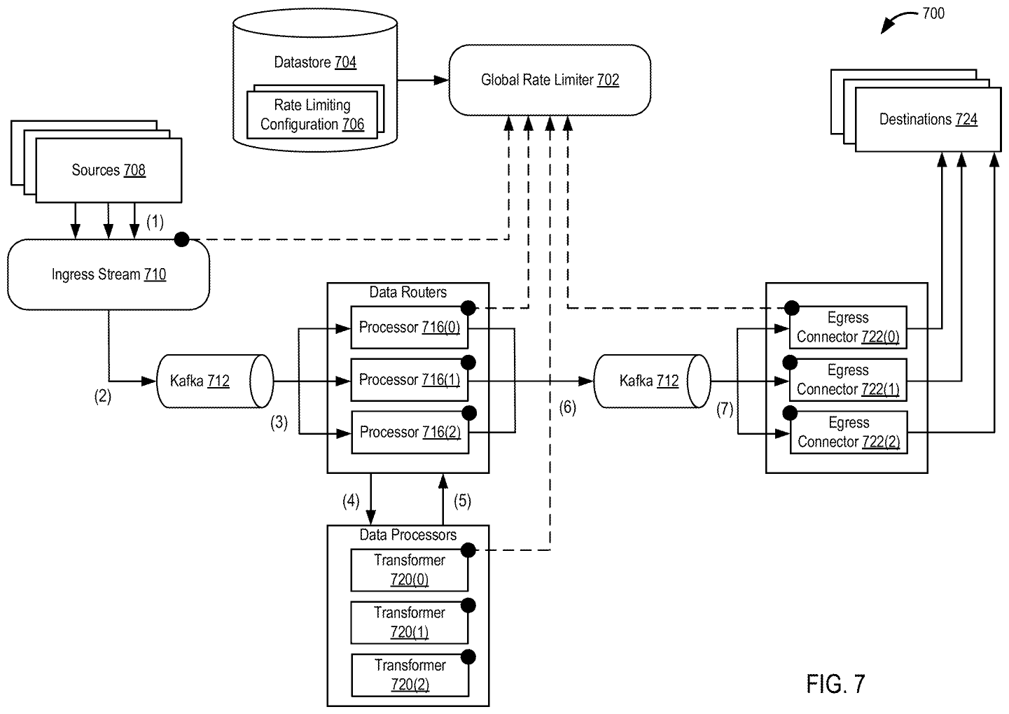

FIG. 7 provides an example service topology 700 where rate limiting policies are centrally configured, according to an example embodiment of the present disclosure. Example service topology 700 may be used to transform data from one or more sources 708 (e.g., customers) such that the data is able to be transported reliably to one or more destinations 724. As such, service topology 700 may support data transformations as well as provide aggregation (e.g. to extract metrics), parsing (e.g., to extract fields or subset data), correlation and joins between data streams, normalization, and/or reordering (e.g. by collection-time or event-time).

As illustrated in FIG. 7, one or more sources 708 (e.g., customers) provide high volumes of data to service topology 700 via ingress connectors (e.g., shown as ingress stream 710). Processors 716(0)-(2) route streams of data to the corresponding transformers 720(0)-(2) that run differential datalog (DDLog). Processors 716(1)-(2) then hand off transformed data results to egress connectors 722(0)-(2). Egress connectors 722(0)-(2) send the transformed data to one or more destinations 724. Kafka 712 is used in service topology 700 as a message queue between stages of data transformation performed by service topology 700. Further, in service topology 700, a single instance of a gateway binary performs both processor and egress functions, thereby sharing resources.

Services performed at ingress stream 710, services performed by processors 716(0)-(2), services performed by transformers 720(0)-(2), and services performed by egress connectors 722(0)-(2) (e.g., microservices) may all be limited based on local rate limits determined by global rate limiters 702. For example, global rate limiter 702 may use rate limiting configurations 706 in datastore 704 to determine rate limits for services performed by ingress stream 710, processors 716(0)-(2), transformers 720(0)-(2), and egress connectors 722(0)-(2) and allocate permits for each of these services accordingly (e.g., based on the determined rate limits).

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for configuring rate limiting policies for a plurality of microservices in a request execution chain of a distributed system, comprising:
receiving, by a global rate limiter, one or more global rate limits, each global rate limit of the one or more global rate limits associated with a corresponding tag and a corresponding microservice of the plurality of microservices, each global rate limit of the one or more global rate limits indicating a rate of requests tagged with the corresponding tag associated with the global rate limit allowed to be processed by the corresponding microservice associated with the global rate limit; and
configuring, by the global rate limiter, for each global rate limit of the one or more global rate limits: each of one or more local rate limiters associated with one or more instances of the corresponding microservice associated with the global rate limit with a local rate limit indicating a rate of requests tagged with the corresponding tag associated with the global rate limit allowed to be processed by the instance of the corresponding microservice associated with the global rate limit, wherein the local rate limit of each of the one or more local rate limiters is based on the global rate limit.

2. The method of claim 1, wherein, for each global rate limit of the one or more global rate limits:
the local rate limit of each of the one or more local rate limiters comprises a number of permits and an associated expiration time.

3. The method of claim 2, further comprising:
receiving, by a first local rate limiter from a first instance of a first microservice associated with the first local rate limiter, a query requesting whether a request comprising a first tag and received by the first instance can be processed;
determining the request can be processed by the first instance based on:
the number of permits allocated to the first local rate limiter being greater than zero, and
a time period since receiving the number of permits allocated by the global rate limiter to the first local rate limiter being less than the expiration time associated with the number of permits; and
transmitting, to the first instance, an indication that the request can be processed.

4. The method of claim 3, wherein the first local rate limiter receives the query from the first instance via a client library.

5. The method of claim 1, wherein, for each global rate limit of the one or more global rate limits: a sum of the local rate limit of each of the one or more local rate limiters is less than the global rate limit.

6. The method of claim 1, further comprising:
identifying, by the global rate limiter, a bottleneck at a first microservice of the plurality of microservices;
determining the bottleneck is due to a number of requests received by the first microservice with a first tag; and
adjusting a first global rate limit associated with a second microservice of the plurality of microservices and the first tag based on the bottleneck.

7. The method of claim 1, wherein at least one tag defined for a first microservice of the plurality of microservices is not defined for a second microservice of the plurality of microservices.

8. A system comprising:
one or more processors; and
at least one memory, the one or more processors and the at least one memory configured to:
receive, by a global rate limiter, one or more global rate limits, each global rate limit of the one or more global rate limits associated with a corresponding tag and a corresponding microservice of a plurality of microservices in a request execution chain of a distributed system, each global rate limit of the one or more global rate limits indicating a rate of requests tagged with the corresponding tag associated with the global rate limit allowed to be processed by the corresponding microservice associated with the global rate limit; and
configure, by the global rate limiter, for each global rate limit of the one or more global rate limits: each of one or more local rate limiters associated with one or more instances of the corresponding microservice associated with the global rate limit with a local rate limit indicating a rate of requests tagged with the corresponding tag associated with the global rate limit allowed to be processed by the instance of the corresponding microservice associated with the global rate limit, wherein the local rate limit of each of the one or more local rate limiters is based on the global rate limit.

9. The system of claim 8, wherein, for each global rate limit of the one or more global rate limits:
the local rate limit of each of the one or more local rate limiters comprises a number of permits and an associated expiration time.

10. The system of claim 9, wherein the one or more processors and the at least one memory are further configured to:
receive, by a first local rate limiter from a first instance of a first microservice associated with the first local rate limiter, a query requesting whether a request comprising a first tag and received by the first instance can be processed;
determine the request can be processed by the first instance based on:
the number of permits allocated to the first local rate limiter being greater than zero, and
a time period since receiving the number of permits allocated by the global rate limiter to the first local rate limiter being less than the expiration time associated with the number of permits; and
transmit, to the first instance, an indication that the request can be processed.

11. The system of claim 10, wherein the first local rate limiter receives the query from the first instance via a client library.

12. The system of claim 8, wherein, for each global rate limit of the one or more global rate limits: a sum of the local rate limit of each of the one or more local rate limiters is less than the global rate limit.

13. The system of claim 8, wherein the one or more processors and the at least one memory configured to:
identify, by the global rate limiter, a bottleneck at a first microservice of the plurality of microservices;
determine the bottleneck is due to a number of requests received by the first microservice with a first tag; and
adjust a first global rate limit associated with a second microservice of the plurality of microservices and the first tag based on the bottleneck.

14. The system of claim 8, wherein at least one tag defined for a first microservice of the plurality of microservices is not defined for a second microservice of the plurality of microservices.

15. A non-transitory computer-readable medium comprising instructions that, when executed by one or more processors of a computing system, cause the computing system to perform operations for configuring rate limiting policies for a plurality of microservices in a request execution chain of a distributed system, the operations comprising:
receiving, by a global rate limiter, one or more global rate limits, each global rate limit of the one or more global rate limits associated with a corresponding tag and a corresponding microservice of the plurality of microservices, each global rate limit of the one or more global rate limits indicating a rate of requests tagged with the corresponding tag associated with the global rate limit allowed to be processed by the corresponding microservice associated with the global rate limit; and
configuring, by the global rate limiter, for each global rate limit of the one or more global rate limits: each of one or more local rate limiters associated with one or more instances of the corresponding microservice associated with the global rate limit with a local rate limit indicating a rate of requests tagged with the corresponding tag associated with the global rate limit allowed to be processed by the instance of the corresponding microservice associated with the global rate limit, wherein the local rate limit of each of the one or more local rate limiters is based on the global rate limit.

16. The non-transitory computer-readable medium of claim 15, wherein, for each global rate limit of the one or more global rate limits:
the local rate limit of each of the one or more local rate limiters comprises a number of permits and an associated expiration time.

17. The non-transitory computer-readable medium of claim 16, wherein the operations further comprise:
receiving, by a first local rate limiter from a first instance of a first microservice associated with the first local rate limiter, a query requesting whether a request comprising a first tag and received by the first instance can be processed;
determining the request can be processed by the first instance based on:
the number of permits allocated to the first local rate limiter being greater than zero, and
a time period since receiving the number of permits allocated by the global rate limiter to the first local rate limiter being less than the expiration time associated with the number of permits; and
transmitting, to the first instance, an indication that the request can be processed.

18. The non-transitory computer-readable medium of claim 17, wherein the first local rate limiter receives the query from the first instance via a client library.

19. The non-transitory computer-readable medium of claim 15, wherein, for each global rate limit of the one or more global rate limits: a sum of the local rate limit of each of the one or more local rate limiters is less than the global rate limit.

20. The non-transitory computer-readable medium of claim 15, wherein the operations further comprise:
identifying, by the global rate limiter, a bottleneck at a first microservice of the plurality of microservices;
determining the bottleneck is due to a number of requests received by the first microservice with a first tag; and
adjusting a first global rate limit associated with a second microservice of the plurality of microservices and the first tag based on the bottleneck.
